(19) United States
(12) Patent Application Publication
(10) Pub. No.: US 2026/0314769 A1
(43) Pub. Date: Oct. 15, 2026

(54) WALLET

(71) Applicant: Statusy Co., Ltd., Otsu-shi (JP)

(72) Inventor: Hirotatsu TANAKA, Otsu-shi (JP)

(21) Appl. No.: 19/645,366

(22) Filed: Apr. 13, 2026

(30) Foreign Application Priority Data
Apr. 14, 2025 (JP) 2025-066539

(51) Int. Cl. A45C 1/06

(52) U.S. Cl. CPC A45C 1/06; A45C 2001/065

(57) ABSTRACT

A wallet has a banknote storage, a first card storage, a second card storage, and a coin storage provided in a wallet body. The wallet body includes a first partition, a second partition, and a side surface. A length direction of a card stored in the first card storage is different from a length direction of a card stored in the second card storage by 90 degrees. Two card storages are provided, and length directions of the cards stored in the card storages are different by 90 degrees. Thus, the wallet can be miniaturized while providing storage for a sufficient number of cards.

### FIELD OF THE INVENTION

The present invention relates to a wallet that stores banknotes, coins, cards, and the like.

### BACKGROUND ART

Various wallets have been developed and sold. For example, a wallet of Patent Document 1 includes a banknote storage, a coin storage, and a card storage. Banknotes, coins, and cards can be separately stored in each storage.

Considering convenience when carrying the wallet, it is conceivable to miniaturize the wallet. Although it is conceivable to miniaturize the wallet by overlapping the card storage, there is a possibility that the thickness of the wallet is increased.

### PRIOR ART DOCUMENT

### Patent Documents

Patent Document 1: JP 3244833 U

### SUMMARY OF THE INVENTION

An object of the present invention is to provide a miniaturized wallet.

A wallet of the present invention includes a first side part, a second side part disposed opposite to the first side part, a bottom connecting long sides of the first side part and the second side part, a first gusset connecting short sides of the first side part and the second side part, a first partition disposed between the first side part and the second side part between the first side part and the second side part, a first card storage that is attached to the second side part, the first partition, or both of the second side part and the first partition, allows a card to be stored, the card having a length direction that coincides with a length direction of the first side part and the second side part, a second partition that separates the second side part and the first partition, and a second card storage constituted by a second side part, a bottom, a first gusset, a first partition, and a second partition, allows a card to be stored, the card having a length direction that is different from the length direction of the card to be stored in the first card storage by 90 degrees.

### EFFECTS OF THE INVENTION

The present invention includes two card storages, and the directions of the cards to be stored are different by 90 degrees. The length direction of the wallet can be shortened, and the thickness can be prevented from increasing.

### BRIEF DESCRIPTION OF THE DRAWINGS

FIG. 1 is a side view showing a wallet of the present invention;

FIG. 2 is a plan view of the wallet of the present invention in an open state;

FIG. 3 is a diagram showing an arrangement position of a card storage with respect to a first partition;

FIG. 4A is a side view showing a wallet of another configuration of this application, and FIG. 4B is a side view showing a state in which the wallet is opened;

FIG. 5 is a perspective view showing a state in which the wallet in FIGS. 4A and 4B is opened; and

FIG. 6 is a diagram showing an overlapped card storage.

### EMBODIMENTS FOR CARRYING OUT THE INVENTION

A wallet of this application will be described with reference to the drawings. A plurality of embodiments are described in this application, common parts are described in one embodiment, and description may be omitted in the other embodiments. In the drawings, a length direction of the wallet is an x-axis direction, a width direction of the wallet is a y-axis direction, and a thickness direction of the wallet is a z-axis direction.

### First Embodiment

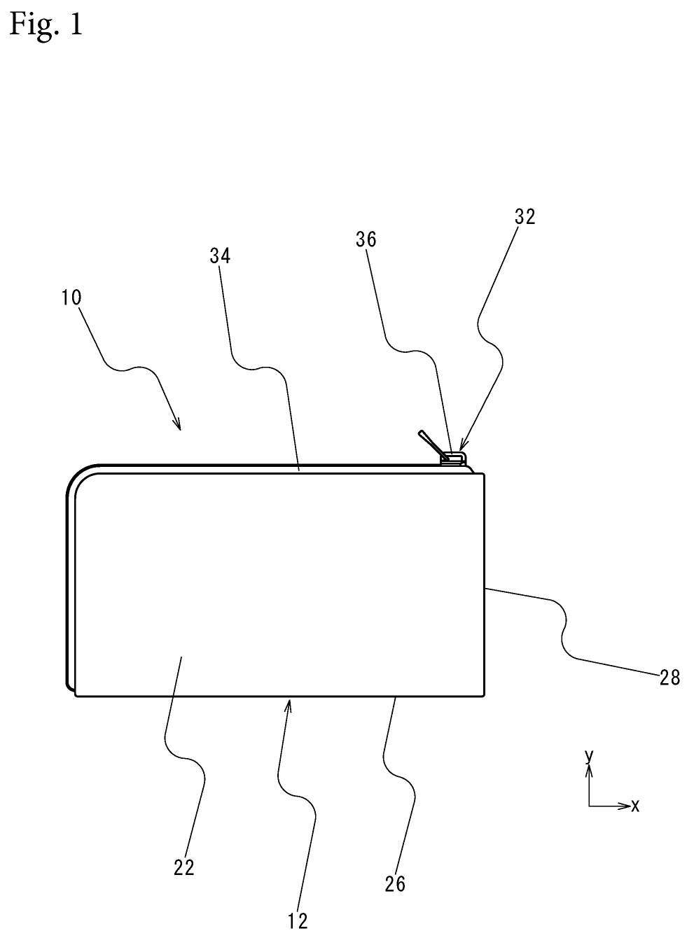

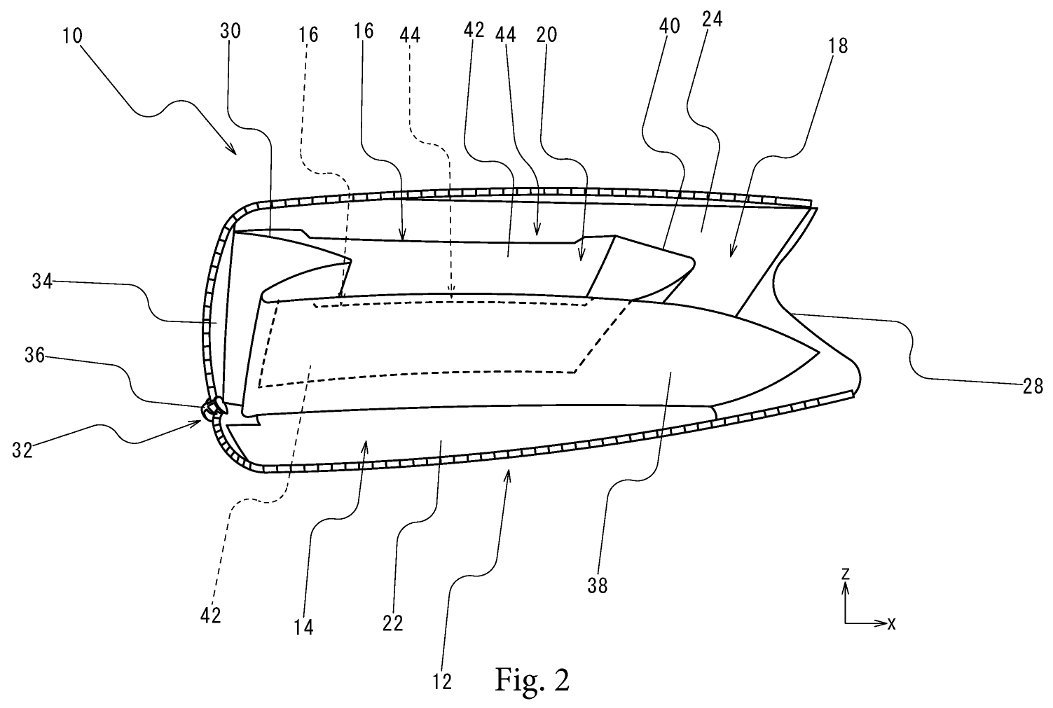

In a wallet 10 of this application shown in FIGS. 1 and 2, a banknote storage 14, a first card storage 16, a second card storage 18, and a coin storage 20 are provided in a wallet body 12.

The wallet body 12 includes a first side part 22, a second side part 24, a bottom 26, a first gusset 28, and a second gusset 30. These members are constituted by a sheet-like material made of leather, synthetic leather, resin, cloth, or the like. Each member may be constituted by stacking the same type or a plurality of types of sheet-like materials. The material may be changed for each member. The material of each member can also deflect.

The first side part 22 and the second side part 24 are rectangular. The corners of the rectangles may be rounded. The first side part 22 and the second side part 24 have the same shape. The length direction (long side direction) of the first side part 22 and the second side part 24 is the length direction (x-axis direction) of the wallet 10, and the width direction (short side direction) is the width direction (y-axis direction) of the wallet 10.

The bottom 26 is disposed between one long side of the first side part 22 and one long side of the second side part 24. When the wallet 10 is closed, the first side part 22 and the second side part 24 are arranged such that the planes of the first side part 22 and the second side part 24 face each other.

The first gusset 28 is disposed between one short side of the first side part 22 and one short side of the second side part 24. The center of the first gusset 28 is bent inward of the wallet body 12. A portion between the center of the first gusset 28 and the first side part 22 and a portion between the center of the first gusset 28 and the second side part 24 may bulge toward the outside of the wallet body 12. When the wallet body 12 is to be widened, the first gusset 28 is widened.

The second gusset 30 is connected to the other short side (short side not connected to the first gusset 28) of the second side part 24. The second gusset 30 is not connected to the other short side (short side not connected to the first gusset 28) of the first side part 22. The center of the second gusset 30 may be bent inward of the wallet body 12.

A tape 34 of a fastener 32 is attached to the other long side of the first side part 22, the other short side of the first side part 22, the other long side of the second side part 24, and the other short side of the second side part 24. By moving a slider 36, the wallet body 12 is opened and closed.

The wallet body 12 includes a first partition 38, a second partition 40, and a side surface 42. Similarly to the wallet body 12, these members are constituted by a sheet-like material such as leather.

The first partition 38 is disposed between the first side part 22 and the second side part 24. The first partition 38 is rectangular. The plane of the first partition 38 is disposed so as to be substantially parallel to the plane of the first side part 22 and the plane of the second side part 24 when the wallet 10 is closed.

One short side of the first partition 38 is disposed near the first gusset 28. One short side of the first partition 38 is not attached to another member. One short side of the first partition 38 can move freely. The other short side of the first partition 38 is attached to the second gusset 30. The second gusset 30 is disposed between the second side part 24 and the first partition 38.

A space surrounded by the first side part 22, the first gusset 28, the bottom 26, and the first partition 38 is the banknote storage 14. The first side part 22 and the first partition 38 are slightly larger than a banknote. The size is such that a banknote can be stored in the banknote storage without being folded. For example, the length of the long side of the first side part 22 is about 16.5mm, and the length of the short side is about 8.9mm. This size may be appropriately changed in accordance with the size of a banknote distributed in countries.

The other short side of the first side part 22 and the other short side of the first partition 38 are not connected to each other. The directions in which banknotes are taken in and out of the banknote storage 14 are increased. Banknotes can be easily taken in and out of the banknote storage 14.

The side surface 42 is attached to the second side part 24, the first partition 38, or both. In FIG. 2, the side surface 42 is attached to both the second side part 24 and the first partition 38. The side surface 42 has a sheet shape or a plate shape and has a rectangular shape. A side portion and a lower portion of the side surface 42 are attached to the above-described members. A card can be stored between the side surface 42 and the second side part 24 and between the side surface 42 and the first partition 38. That is, the side surface 42 and the second side part 24, and the side surface 42 and the first partition 38 constitute the first card storage 16. The length direction of a card stored in the first card storage 16 coincides with the length direction (x-axis direction) of the wallet 10. A cutout 44 may be provided in an upper portion of the side surface 42 so that cards can be easily taken in and out. The number of cards stored in the first card storage 16 is not limited to one, and a plurality of cards may be stored.

The second partition 40 is attached to the second side part 24 and the first partition 38. The second partition 40 may be integrated with the side surface 42. For example, two side surfaces 42 are provided, and a second partition 40 is provided between the side surfaces 42. One side surface 42 is attached to the first partition 38, and the other side surface 42 is attached to the second side part 24. The second partition 40 is disposed between the first partition 38 and the second side part 24. In the x-axis direction, a space between the second side part 24 and the first partition 38 is divided into two by the second partition 40.

The second partition 40 may be bent so as to bulge toward the first gusset 28. A space surrounded by the second side part 24, the bottom 26, the first gusset 28, the first partition 38, and the second partition 40 is the second card storage 18. The length direction of a card stored in the second card storage 18 coincides with the width direction (y-axis direction) of the wallet 10. The second card storage 18 may store a plurality of cards.

Cards stored in the card storages 16 and 18 are a credit card, a cash card, and the like. For example, the dimensions of credit cards are determined by the international standard “ID-1”, and the length direction is 53.98mm, the width direction is 85.60mm, and the thickness is 0.76mm. Each of the card storages 16 and 18 can store such a card.

The length direction of a card stored in the first card storage 16 is different from the length direction of a card stored in the second card storage 18 by 90 degrees. The second card storage 18 is disposed so as to be in contact with the first gusset 30, and the first card storage 16 is disposed so as to be in contact with the second gusset 28. The first card storage 16 and the second card storage 18 are disposed adjacent to each other in the length direction (x-axis direction) of the wallet 10. The first card storage 16 and the second card storage 18 are not overlapped in the thickness direction (z-axis direction) of the wallet 10. Under the above conditions, the length direction (x-axis direction) of the wallet 10 can be shortened. Since the first card storage 16 and the second card storage 18 do not overlap each other in the width direction of the wallet 10, the thickness (z-axis direction) of the wallet 10 can be reduced. The number of cards that can be stored can be increased by providing the two card storages 16 and 18.

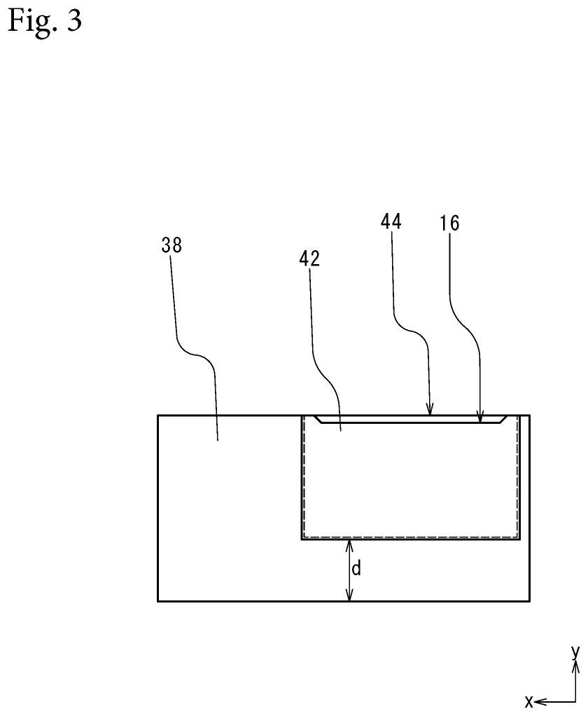

A space formed by the second side part 24, the bottom 26, the first partition 38, the second gusset 30, and the second partition 40 is defined as the coin storage 20. The first card storage 16 is provided on the second side part 24, the first partition 38, or both of the second side part 24 and the first partition 38. An interval d is provided between the first card storage 16 and the bottom 26 (FIG. 3). It is preferable that the interval d makes it difficult for coins to come into contact with the first card storage 16 when the coins are put into the coin storage 20. Since the cards and the coins do not overlap each other, the thickness of the wallet 10 can be kept thin. Even at the height of the first card storage 16 in the coin storage 20, coins can be stored so as to overlap the cards.

The number of cards that can be stored in the first card storage 16 is smaller than the number of cards that can be stored in the second card storage 18. For example, the number of cards that can be stored in the first card storage 16 is set to be equal to or less than half of the number of cards that can be stored in the second card storage 18. Even if cards are stored in the first card storage 16 and coins are further stored in the coin storage 20, the thickness of the wallet 10 is less likely to increase.

As described above, this application includes the two card storages 16 and 18, and the length directions of the cards stored therein are different by 90 degrees. It is possible to miniaturize the wallet 10 while providing a sufficient number of cards that can be stored.

### Second Embodiment

In the first embodiment, the fastener 32 is used as a member for opening and closing the wallet 10, but the member for opening and closing is not limited to the fastener 32. For example, a button, a hook, a magnet, or the like may be used instead of the fastener 32. A case where the button is used will be described.

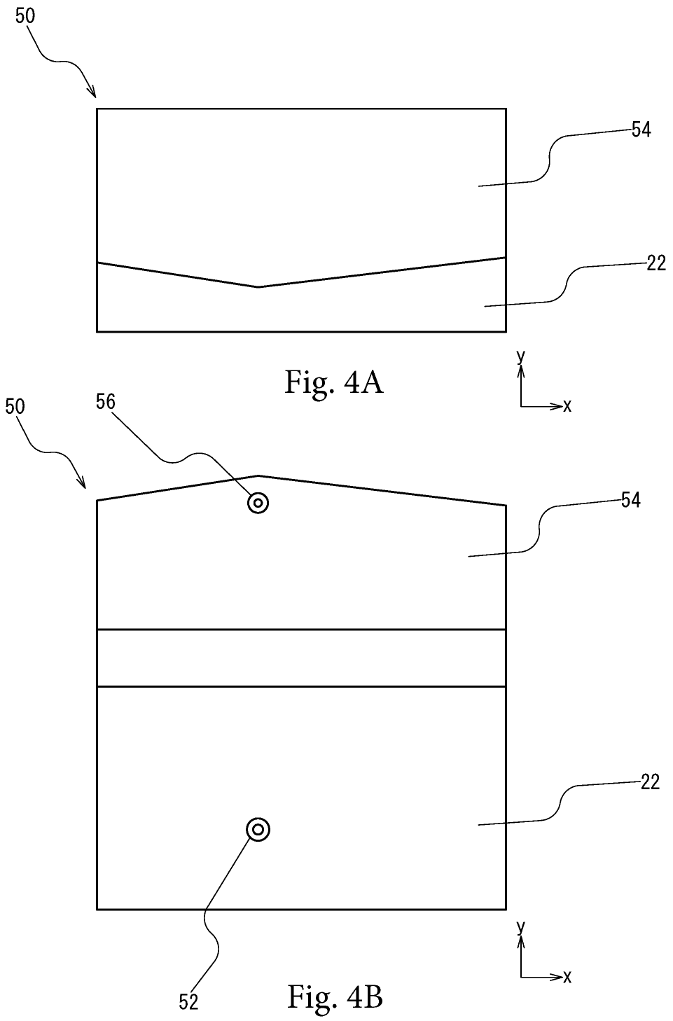

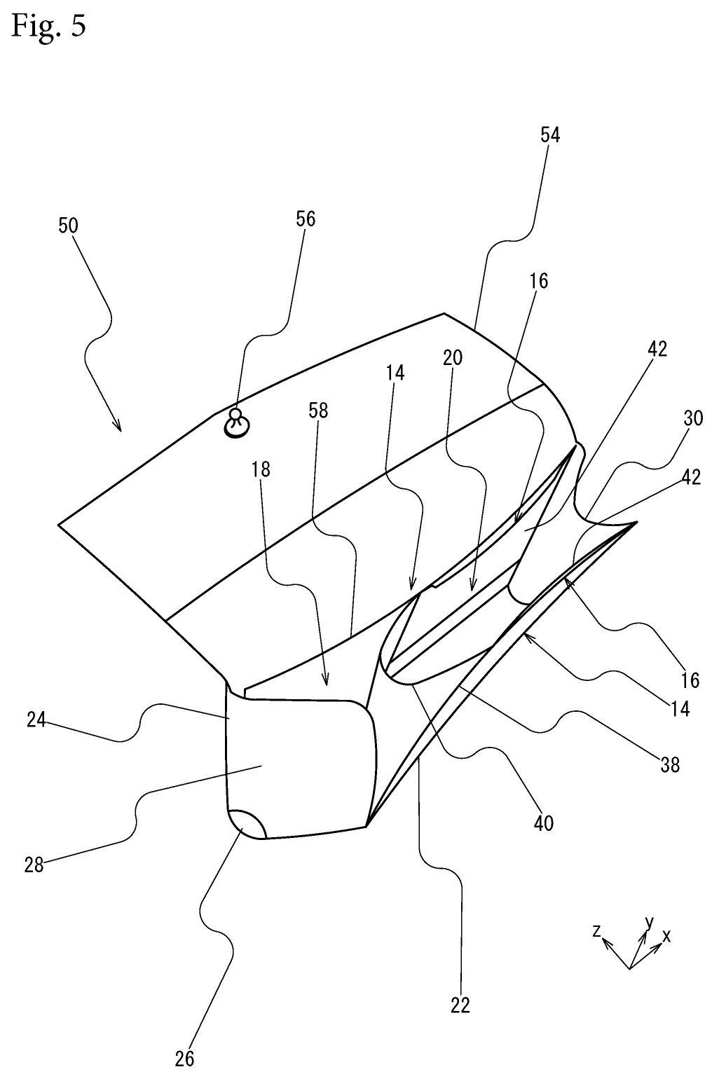

As in the wallet 50 in FIGS. 4A, 4B, and 5, a spring 52 is attached to the first side part 22. The second side part 24 is provided with a lid 54 overlapping the first side part 22. When the lid 54 is bent and overlaps the first side part 22, the wallet 50 is closed. A dowel 56 is attached to the lid 54. The wallet 50 can be closed by fitting the spring 52 and the dowel 56.

Each short side of the first partition 38 is attached to each short side of the first side part 22. The banknote storage 14 is formed between the first side part 22 and the first partition 38.

The second gusset 30 is attached to the first side part 22 and the second side part 24. This is to close the wallet 50 since there is no fastener 32 as in the first embodiment.

A third partition 58 may be provided between the second side part 24 and the first partition 38. The third partition 58 may overlap the second side part 24. The third partition 58 may have the same shape as the first partition 38. The two short sides of the third partition 58 are not required to be attached to another member. The second partition 40 is attached to the first partition 38 and the third partition 58. The banknote storage 14 may be formed between the second side part 24 and the third partition 58. Two banknote storages 14 are provided.

The other members are similar to those in the first embodiment. Similarly to the wallet 10 according to the first embodiment, the wallet 50 according to a second embodiment includes a banknote storage 14, two card storages 16 and 18, and a coin storage 20. The directions of the cards stored in the two card storages 16 and 18 are different by 90 degrees, and the wallet 50 can be miniaturized.

### Third Embodiment

Although the third partition 58 is provided in the second embodiment, the third partition 58 may be similarly provided in the first embodiment, and two banknote storage units 14 may be provided.

In the second embodiment, the third partition 58 is not required to be provided, and the second partition 40 may be attached to the second side part 24 as in the first embodiment.

### Fourth Embodiment

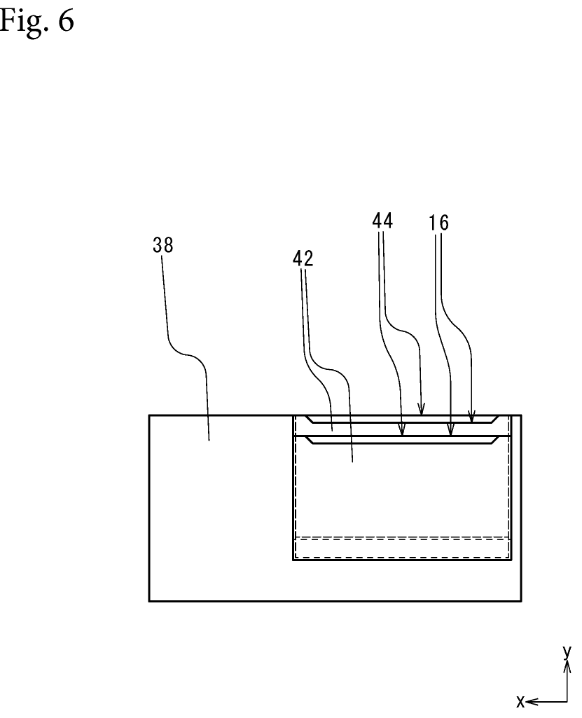

As shown in FIG. 6, a plurality of side surfaces 42 may overlap. The plurality of first card storages 16 are arranged in an overlapping manner. The plurality of side surfaces 42 may overlap while changing in height in the y-axis direction.

### Fifth Embodiment

In the above embodiment, the positions of the members may be reversed with the first partition 38 as a center. Since the positions of the members are reversed, the members are for right-handed and left-handed users.

As for the members described in the above embodiment, a plurality of members may be integrated, or may be sewn or joined.

In addition, the present invention can be implemented in a mode in which various improvements, modifications, and changes are added on the basis of the knowledge of those skilled in the art without departing from the gist of the present invention.

### DESCRIPTION OF REFERENCE SIGNS

10, 50 wallet
12 wallet body
14 banknote storage
16 first card storage
18 second card storage
20 coin storage
22 first side part
24 second side part
26 bottom
28 first gusset
30 second gusset
32 fastener
34 tape of fastener
36 slider
38 first partition
40 second partition
42 side surface
44 cutout of side surface
52 spring
54 lid
56 dowel
58 third partition

We claim:

1. A wallet comprising:
a first side part;
a second side part disposed opposite to the first side part;
a bottom connecting long sides of the first side part and the second side part;
a first partition disposed between the first side part and the second side part between the first side part and the second side part;
a first card storage that is attached to the second side part, the first partition, or both of the second side part and the first partition, allows a card to be stored, the card having a length direction that coincides with a length direction of the first side part and the second side part;
a second card storage that does not overlap the first card storage in a thickness direction of the wallet, allows a card to be stored, the card having a length direction that is different from the length direction of the card stored in the first card storage by 90 degrees; and
an interval that is provided between the first card storage and the bottom and in which a coin is put,
wherein the card stored in the first card storage and the coin put in the interval do not overlap each other.

2. The wallet according to claim 1, further comprising a first gusset connecting short sides of the first side part and the second side part,
wherein one short side of the first partition is not fixed to the first gusset, and one short side of the first partition is freely movable.

3. The wallet according to claim 2, further comprising a second partition that separates the second side part and the first partition,
wherein the second card storage is constituted by the second side part, the bottom, the first gusset, the first partition, and the second partition.

4. The wallet according to claim 3 comprising:
a second gusset connecting the second side part and the first partition; and
a coin storage that is constituted by the second side part, the bottom, the first partition, the second partition, and the second gusset, and allows a coin to be stored.

5. The wallet according to claim 2, wherein the first side part, the bottom, and the first gusset constitute a banknote storage that allows a banknote to be stored.
